(19) United States
(12) Patent Application Publication
(10) Pub. No.: US 2011/0162035 A1
(43) Pub. Date: Jun. 30, 2011

(54) LOCATION-BASED DOCK FOR A COMPUTING DEVICE

(75) Inventors: Nicholas Vincent King, San Jose, CA (US); Aleksandar Pance, Saratoga, CA (US); Brett Bilbrey, Sunnyvale, CA (US)

(73) Assignee: Apple Inc., Cupertino, CA (US)

(21) Appl. No.: 12/650,870

(22) Filed: Dec. 31, 2009

(51) Int. Cl. G06F 15/177; G06F 9/24; G06F 21/22; G06F 21/20

(52) U.S. Cl. 726/1; 713/100; 709/221

(57) ABSTRACT

One particular implementation conforming to aspects of the present disclosure takes the form of docking station for a computing device that maintains an indication of a docking station location. The location of the docking station may be utilized by the docking station and/or the computing device coupled to the docking station to configure the functionality and other aspects of the computing device. For example, the functionality of the computing device may be altered in response to the location of the docking station. Additionally, security features, display configurations and the availability of software applications may also be configured in response to the location of the docking station. In this manner, a single computing device may perform the functions of several computing devices based on the location of the docking station, without the need for the user of the device to configure the device manually.

### TECHNICAL FIELD

This invention relates generally to docking stations for computing devices, and more specifically to methods and apparatus for altering the configuration and functionality of a computing device based on a location of a docking station in which the computing device is docked.

### BACKGROUND

Many portable computing devices, such as notebook or laptop computers, personal digital assistants (PDAs), cell phones, etc. are designed to be lightweight and compact for ease in transportability. However, the compact and lightweight design of such devices often limits the number and types of peripheral devices that are available to the computing device.

One way to increase the versatility of a portable computing device is couple the computing device to a docking station that provides connections between one or more peripheral devices. A docking station, when connected to a portable computing device, often provides for a number of different types of ports that may not be feasible on a small and lightweight portable device. For example, the docking station may provide one or more ports to drive a large monitor, communicate with various peripherals, provide connection to a network, provide power to the portable device, and so forth.

Docking stations are typically passive devices, providing straight-through connections to a network and other peripheral devices through a matching interface located on the computing device. Thus, a computing device docked at a docking station located at a user's home may provide the same functionality when the same device docked at a docking station located at the user's work office, the only difference being the type and number of peripherals coupled to the docking station at each location.

Thus, it is often left to the user to configure the computing device for use at different locations by accessing or selecting the proper software applications and security measures for the computing device based on the location of the docking station coupled to the device. However, such configuration of the device may be both time-consuming and confusing to a non-sophisticated user. Thus, what is needed is docking station that determines the location of the docking station, and subsequently the computing device coupled to the docking station, and alters the functionality and configuration of the computing device based on the device's location.

### SUMMARY

One embodiment may take the form of a method for configuring a computing device. The method may include the operations of receiving a location indicator of a docking station coupled to a computing device, selecting a system configuration of the computing device based on the location indicator and altering the functionality of the computing device based on the determined system configuration.

Another embodiment may take the form of a docking station for a computing device. The docking station may include a processor and a machine-readable medium configured to maintain a location indicator that indicates a location of the docking station. In addition, the docking station may include an interface configured to couple to a computing device to provide the location indicator to the computing device such that the computing device alters the functionality of the computing device in response to the location indicator.

Yet still another embodiment may take the form of a system for configuring the functionality of a computing device based on a location. The system may include a computing device and docking station configured to communicate with the computing device such that a functionality of the computing device is selected based on a location indicator provided by the docking station to the computing device.

### BRIEF DESCRIPTION OF THE DRAWINGS

FIG. 1 depicts an isometric view of an exemplary laptop or notebook computing device and a corresponding docking station.

FIG. 2 depicts the locations of several docking stations that a computing device may couple with to provide separate functionality and security features to the computing device.

FIG. 3 depicts a block diagram of a plurality of messages passed between a computing device and a docking station to provide location-based functionality to the computing device.

FIG. 4 is a flow chart of a method for a docking station to alter the functionality of a computing device based on the location of the docking station.

FIG. 5 is a flow chart of a method for a docking station to alter the functionality of a computing device into a work-related computing device based on the location of the docking station at a work location.

FIG. 6 is a flow chart of a method for a docking station to alter the functionality of a computing device into a navigation-related computing device based on the location of the docking station in a user's vehicle.

FIG. 7 is a flow chart of a method for a docking station to alter the functionality of a computing device into a television-related computing device based on the location of the docking station in a television viewing location.

FIG. 8 is a flow chart of a method for a docking station to alter the functionality of a computing device into an electronic picture frame based on the location of the docking station in a picture viewing location.

FIG. 9 is a block diagram illustrating an exemplary computing device or docking station which may be used in implementing embodiments of the present disclosure.

### DETAILED DESCRIPTION OF THE INVENTION

One particular implementation conforming to aspects of the present invention takes the form of docking station for a computing device, such as a laptop computer or personal digital assistant. In one embodiment, the docking station may be provided with and maintain an indication of a location in which the docking station is located. In another embodiment, the docking station may receive an indication of a location from a computing device or network periodically or when the device or network is coupled to the docking station. The determined location of the docking station may be utilized by the docking station and/or the computing device coupled to the docking station to configure the functionality and other aspects of the computing device when the device is docked.

In one embodiment, the docking station sends a signal to the computing device with an indication of the docking station's location, which typically corresponds to the location of the computing device. In response to the location sent from the docking station, the computing device may be configured in a variety of ways. For example, the functionality of the computing device may be altered in response to the location of the docking station. Additionally, security features, display configurations and the availability of software applications may also be configured in response to the location of the docking station. In this manner, a single computing device may perform the functions of several computing devices based on the location of the docking station in which the computing device is docked, without the need for the user of the device to configure the device manually.

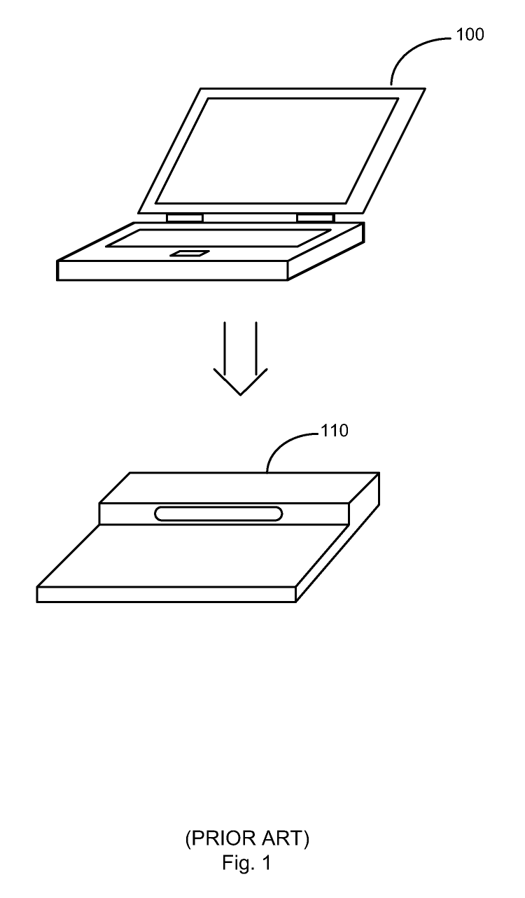

FIG. 1 depicts an exemplary laptop or notebook computing device 100 and a corresponding docking station 110 that provides additional connectivity to peripheral devices for the computing device. It should be noted that the computer 100 shown in FIG. 1 is depicted as a notebook computer purely for convenience. The computer could be any form of electronic device, such as a desktop computer, handheld computing device, personal digital assistant, mobile telephone, music or audio player (such as an MP3 player), health or medical device, auto/vehicle-mounted device, gaming console, display device, wireless internet device, backup storage device and so on. Accordingly, a “computing device,” as used generally herein, encompasses all such devices and any other electronic device having a processor for performing mathematical or computational operations and displaying the results to a user of the device.

Likewise, the docking station 110 depicted in FIG. 1 is depicted as a docking station for a notebook computer purely for convenience. The docking station 110 could be any docking station that matches or corresponds to an interface of the electronic devices set out above. Thus, the docking station 110 could be a docking station for a desktop computer, handheld computing device, personal digital assistant, mobile telephone, music or audio player (such as an MP3 player), health or medical device, auto/vehicle-mounted device, and so on. Generally, a “docking station” as used herein encompasses any docking device that provides some connectivity between a computing device and a peripheral to the computing device, such as a monitor, a network, provides power to the device, etc.

Docking stations are often modular by design such that a portable electronic device may dock with a plurality of similar docking stations at different locations. For example, a user may utilize one laptop docking station at the user's work location and another laptop docking station at the user's home, such that the same laptop computer may be accessed by the user when located at either work or home. Thus, the docking stations allow a user access to a computing device at several locations simply by removing the device from a first docking station and docking with another docking station.

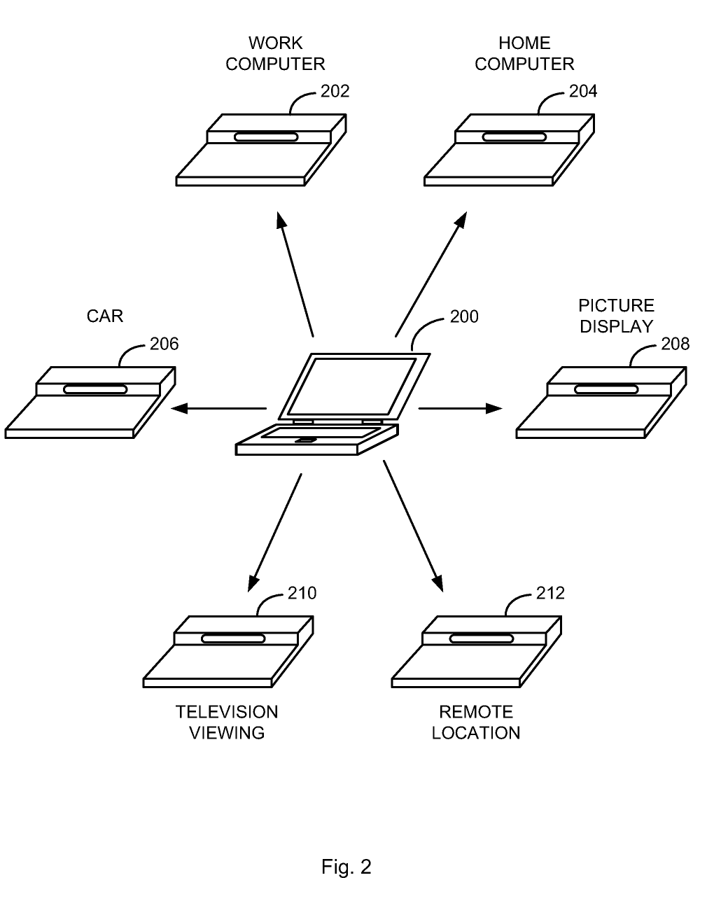

FIG. 2 depicts a block diagram of the several locations of a plurality of docking stations 202-212 that a computing device 200 may dock with to provide separate functionality and security features to the computing device. The docking stations 202-212 may be structurally similar, including a similar interface, such that the computing device 200 can easily dock with the docking stations. Further, each docking station 202-212 may maintain or receive an indication of the location of the docking station and may be configured to provide such an indication to the computing device 200 when the device is docked with the station.

In addition, the location of each docking station 202-212 may be such that a separate functionality of the computing device 200 is desired at each location. For example, when docked in a docking station 202 located at a user's work, the user may desire to utilize the computing device 200 as a work-related computer, capable of accessing the user's work emails and work calendar, along with several work-related software programs. When docked in a docking station 204 at home, however, the computing device 200 is most likely utilized as a home computer, possibly accessing the user's personal email accounts, personal calendar, music management software, gaming programs, etc. Thus, in one embodiment of the present disclosure, the functionality of the computing device 200 can be altered based on the location indicator received from the docking station in which the device is docked. In this manner, the operation of manually configuring the computing device 200 as desired by the user may be performed automatically by the computing device or the docking station based on a location indicator provided by the docking station.

As mentioned above, docking stations 202-212 corresponding to a particular computing device 200 may be located in several places. For example, in addition to a work-related docking station 202 and home-related docking station 204, the user may also have a docking station 206 in the user's car, a docking station 210 in a location used for viewing television and a docking station 208 location intended for an electronic picture frame. Further, a docking station for the computing device 200 may be portable such that the user may carry the docking station to a remote location to interface with one or more computing peripherals at the remote location. Thus, the user may also have a remotely located docking station 212, possibly used during travel. It should be noted that the docking station locations 202-212 discussed above and included in FIG. 2 are mere examples of the several locations where a user may have a docking station. Generally, docking stations may be located anywhere as desired by the user for ease of use of the computing device 200.

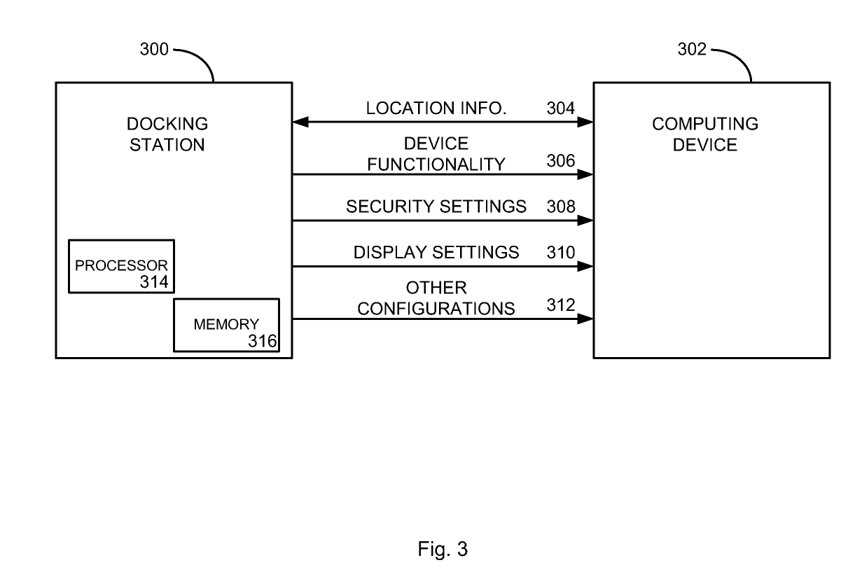

As mentioned above, each of the docking stations 202-212 in the various locations may maintain or receive an indication of the station's location for the purpose of configuring a computing device 200 coupled to the docking station. Thus, when a computing device 200 is docked with a particular docking station, the location of that docking station may first be transmitted to the computing device. In response to receiving the docking station location, several aspects of the computing device may be configured. FIG. 3 depicts a block diagram of a plurality of messages passed between a computing device 302 and a docking station 300 to provide location-based functionality to the computing device.

As shown in FIG. 3, a computing device 302 is in communication with a docking station 300. The computing device 302 and docking station 300 may take the form of any of the examples provided above. When docked, the computing device 302 may communicate with the docking station to receive one or more types of information 304-312 from the docking station 300. This information may be utilized by the computing device 302 to configure the functionality and settings of the computing device in response to the location of the docking station 300.

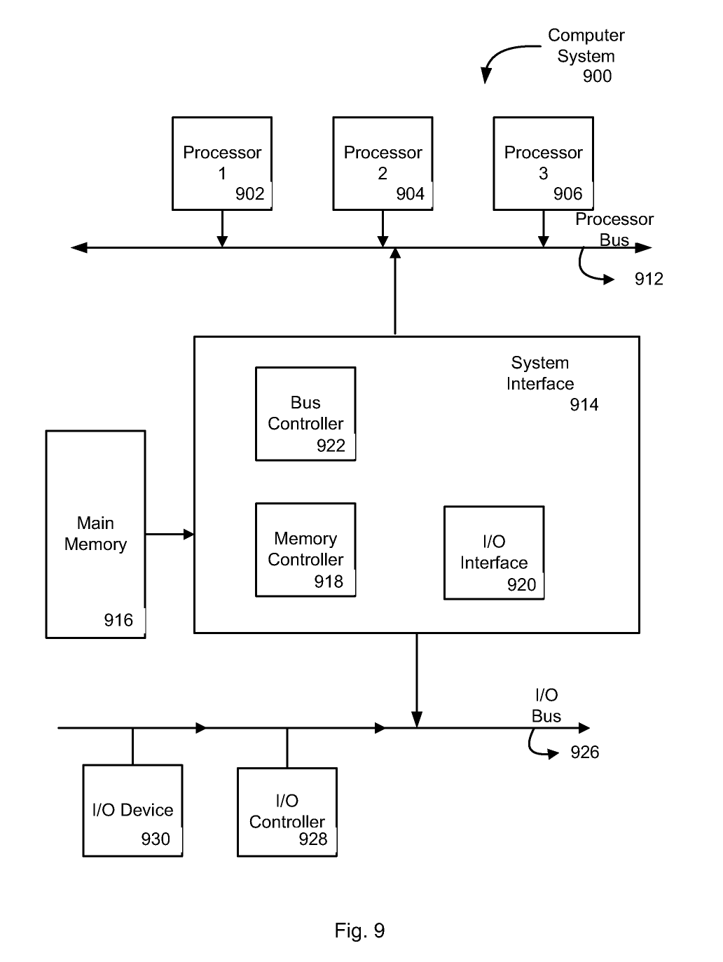

Initially, the docking station 300 may receive and/or maintain its location in several ways. This is shown in FIG. 3 by the communication of the docking station location 304 between the computing device 302 and the docking station 300. To facilitate the determination of the location of the docking station 300, the docking station may include a processor 314 and machine-readable medium 316 (labeled “memory” in FIG. 3) to receive the docking station's location and store such location for later use by the station. The processor 314 and machine-readable medium 316 may take the form as described in more detail below with reference to FIG. 9. In one embodiment, the docking station 300 is configurable to receive and store the docking station's location during a configuration mode. In this embodiment, the docking station 300 may enter a configuration mode and receive the location of the docking station from the computing device 302 or another electronic device. The transfer of the location to the docking station 300 may be performed by a computing device 302 that is docked with the docking station. In this example, the user utilizes one or more software applications of the computing device 302 to instruct the docking station 300 to enter the configuration mode and to provide the desired location indicator to the docking station.

Upon receipt, the docking station 300 may store the location in the machine-readable medium 316 of the station such that the location is accessible by the docking station during communication with a computing device 302. In this embodiment, the location provided to the docking station 300 may be maintained by the station until a new location is provided to the station through the configuration mode. Thus, regardless of the physical location of the docking station 300, the location identifier of the station will not change until a new configuration is provided to the station through the operations outlined above. This particular method of configuring the docking station may be useful if a user has two docking stations at a single location that he wishes to use for different computing configurations. Thus, the user may program one docking station to provide a first functionality and a second docking station to provide a second functionality, regardless of the detected position of the docking stations.

In another embodiment, the location of the docking station 300 may be dynamic such that it can change based on the physical location of the docking station. For example, the docking station 300 may receive a new location from a computing device 302 whenever a computing device docks with the station. In this example, the computing device 302 may acquire a location from one or more sources, such as global positioning system (GPS), a network or wi-fi identification or manually from the user. This location is then provided to the docking station 300 whenever the computing device 302 is docked with the station. This particular embodiment may be useful for a portable docking station as the location of the docking station may vary over time.

In yet another embodiment, the docking station 300 may obtain its location from a source other than the computing device 302. For example, the docking station 300 may include a GPS device to determine its location. Alternatively, in those configurations where the docking station 300 is connected to a network, the station may utilize a network internet protocol (IP) address or other identifying measures to determine the location of the docking station. For example, the docking station 300 may connect, either directly through a network connection or wirelessly, to a public network. This network may have an indication of the network's location such that the docking station 300 may determine its location based on the identification of the network. Generally, the docking station 300 may use any method available to a computing device to determine its location. In still another embodiment of the present disclosure, the docking station 300 may use several such methods to determine its location.

Regardless of the methods employed by the docking station 300 to obtain its location, such information may be used by the docking station and the computing device 302 to tailor the functionality and settings of the computing device in response. As shown in FIG. 3, several aspects of the computing device 302 may be altered in response to the docking station 300 location information. Particularly, the docking station 300 location may determine the functionality of the computing device 306 (computer, television, digital frame, navigation device, etc.), the security settings 308 of the device, display settings 310 and other configurations 312 of the computing device. Information to control such aspects of the computing device 302 may be passed between the computing device and the docking station 300 as outlined below.

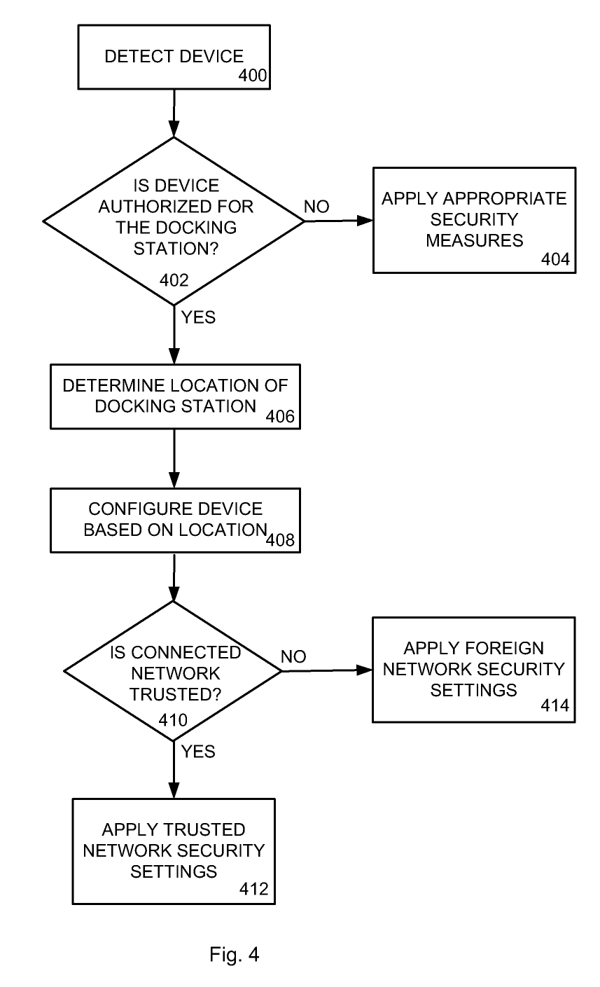

In one embodiment, the computing device 302 sets and controls the various aspects of the device in response to the received location of the docking station 300. In this embodiment, the location of the docking station 304 is passed to the computing device 302 when the device is docked into the station. Once received, the computing device 302 may access a file or look-up table that maintains one or more different configurations of the device based on the location information 304 received from the docking station 300. For example, the docking station 300 may provide a location 304 to the computing device 302 that indicates that the docking station is located in a television viewing area, such as a living room of a user or on an entertainment center. Once the location of the docking station 300 is received, the computing device 302 may determine which configuration matches the received location 304. In this example, the computing device 302 may load a television viewing configuration that facilitates watching television programs through the computing device. Thus, the computing device 302 may automatically load one or more hardware drivers and software applications for viewing television online, as well as activating speakers connected to the docking station 300, among several other features of the computing device that may be loaded or activated upon determination of the location of the device. Generally, several software and hardware aspects of the computing device 302 may be altered or set in response to the received location information 304 of the docking station 300. In addition, any unrecognized location may cause the computing device 302 to load a default configuration, perhaps with expanded security to prevent unauthorized access to the computing device. The various aspects of the computing device that may be altered in response to the determined docking station location are discussed in more detail below with reference to FIGS. 4-8.

In another embodiment, the docking station 300 determines the configuration of the docked computing device 302 in response to the determined location. In this example, the processor 314 and machine-readable medium 316 components of the docking station 300 may act in accord to determine the proper configuration for the computing device 302, perhaps by accessing a file or look-up table maintained by the docking station 300. Once the proper configuration and settings are obtained by the docking station 300, such information may be passed to the computing device 302 to alter the settings of the device. Such information may include those communications shown in FIG. 3, namely device functionality 306, security setting 308, display settings 310 and any other configuration settings 312 that are location-based.

In yet another embodiment, the computing device 302 and the docking station 300 may share duties in configuring the computing device in response to the location information 304 of the docking station. For example, the computing device 302 may alter the functionality of the computing device and various other configuration settings while the docking station 300 may control the security settings 308 of the computing device in response to the determined location.

As described herein, the computing device 302 physically docks with the docking station 300 through an interface. However, it is also contemplated that the computing device 302 may dock with the docking station 300 wirelessly. In this embodiment, the computing device 302 and the wireless docking station 300 broadcast communications between the device and the station to wirelessly dock the computing device with the docking station. Thus, as used herein, the term “docking” could be a physical docking of the computing device with the docking station or a wireless docking with a wireless docking station.

Further, the embodiments described herein discuss providing a location to the computing device 302 to alter the configuration of the device. However, any type of information may be provided to the computing device 302 from the docking station 300 to alter the functionality of the device. For example, rather than providing a location, the docking station 300 may provide a configuration suggestion, such as “computer”, “television”, “navigation device”, or the like that directs the computing location to configure certain hardware components and adopt a particular group of settings associated with the configuration suggestions. Alternatively, the docking station 300 may provide a code or other identifier that represents or indicates the suggested configuration to the computing device 302. Still further, the docking station 300 may provide information in addition to the location or configuration code, such as date and time, that may further be used by the computing device 302 to customize and configure the device.

FIG. 4 is a flow chart of a method for a docking station to alter the functionality of a computing device based on the location of the docking station. Through this method, the functionality of a computing device may be automatically configured in response to the engagement of the computing device with a docking station, based on the docking station's location.

Beginning in operation 400, the docking station detects the docking of a computing device. In the embodiments where the computing device is physically docked with the docking station, this detection may occur when the device is clicked in or otherwise engaged in the docking station. In the embodiments utilizing a wireless docking station, the detection may occur when the computing device is within range of the wireless docking station.

Once detected, the docking station may perform a security check on the computing device in operation 402 to determine if the computing device is authorized to access the docking station. The determination may take the form of a password or identification number of the computing device that is recognized by the docking station. In those situations where the computing device is not authorized or recognized by the docking station, the docking station may refuse to communicate with the computing device. This prevents a foreign computing device from accessing a docking station in an attempt to access the connected peripherals. In another embodiment, the docking station may trigger a lock on the computing device that prevents a user from accessing the device in operation 404 to provide further security. Even stronger security measures may be taken by the computing device and docking station, such as security based on public key cryptography and/or digital signatures. Generally, any computerized security scheme may be employed and utilized with the computing device and docking station.

If the computing device is authorized to access the docking station, then the docking station may determine its location in operation 406. The location of the docking station, and consequently the computing device that is docked with the docking station, may be determined by the computing device and transmitted to the docking station or determined by the docking stations itself in any manner described herein.

Upon determination of the docking station location, the computing device may be configured in response to the determined location in operation 408. As described, several aspects of the computing device may be configured in response to the determined location, including the functionality of the device by activating one or more hardware components and accessing one or more available software programs, the display settings, security measures and many other configuration settings.

Several additional security operations may also be taken once the configuration and location of the computing device is determined. In operation 410, the computing device and/or docking station may determine if the docking station is connected to a network, either through a network connection or wirelessly, and whether the network can be trusted. For example, the computing device may be configured to recognize certain networks, such as a network in use at a user's work location. The work network may be identified by the computing device as a friendly or trusted network in which the computing device is free to communicate over the network. Thus, in operation 412, if it is determined that the network connected to the docking station is trusted, then the computing device settings related to network communicating may be set at a low security level, possibly requiring a simple password to access. However, if the network is not recognized as a secure network, than a separate set of network security measures may be applied to the computing device in operation 414. For example, if the docking station is portable and is connected to a foreign network, such as one in a hotel room, than the docking station may provide such information to the computing device in operation 414 such that the network settings of the computing device is set a higher level. For example, the computing device may provide more warnings to the user during use of the network or prevent the user from accessing certain websites or network addresses entirely. The additional network security features applied to the computing device in response to the type of network connected to the docking station is just one of several security aspects that can be configured based on the determined location of the docking station.

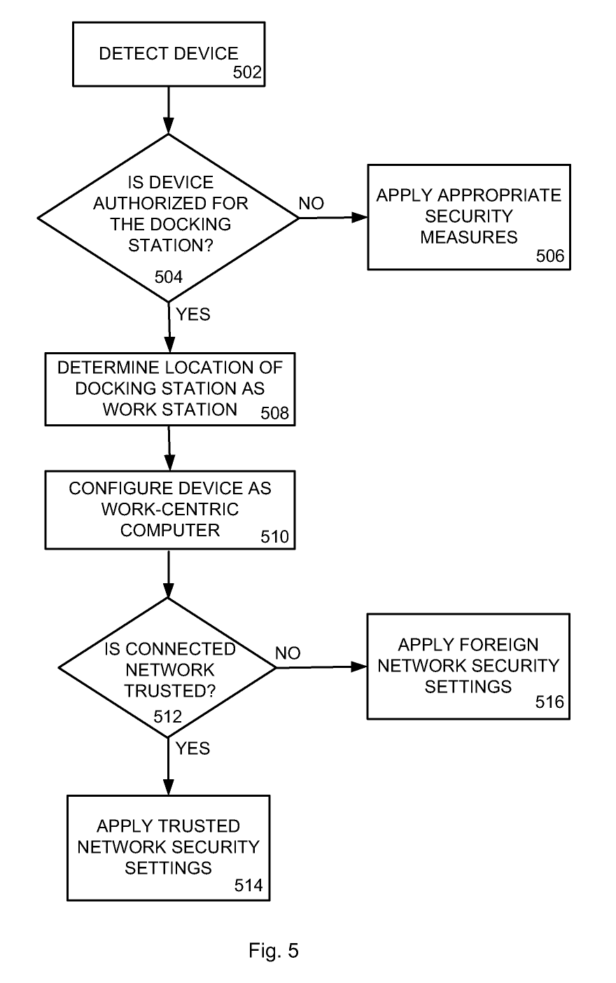

As mentioned above, the determined location of the docking station may alter many aspects of the docked computing device. For example, FIG. 5 is a flow chart of docking station altering the functionality of a computing device into a work-related computing device based on the location of the docking station at a work location.

Several operations of this method are discussed above with reference to FIG. 4. Particularly, the computing device is detected by the work-related docking station in operation 502 and a determination is made as to whether the device is authorized to access the docking station in operation 504. If it is determined that the computing device is not authorized, the docking station may lock the device or otherwise prevent the device from accessing the network in operation 506. In operation 508, the docking station identifies its location as being located at the user's work, such as in the user's office.

In response to the identification of the docking station, several aspects of the computing device are set in response to the docking station providing a work location to the device in operation 510. Generally, the functionality of the computing device is configured into a work-related computer such that the user can utilize the device for work-related activities. In addition, several other aspects of the computing device may also be configured in relation to a work configuration maintained by the device.

For example, certain work-related software applications may be initialized in preparation for use in work-related activities. In addition, an icon for one or more of these applications may be placed on the desktop of the computing device for ease in access by the user. Other applications that are not used during work-related activities may be hidden or deactivated by the computing device. In one particular example, a work-centric email program may be loaded and provided to the user automatically upon the determination of the computing device being docked at a docking station located at work. A work-centric background and other display settings may also be configured at the computing device. In addition, drivers for one or more work-related printers may be loaded and assigned as preferred printers in the work-centric configuration. Several hardware components of the computing device may also be activated in response to the location of the docking station.

Several security measures may also be employed in the work-centric configuration. For example, the computing device may maintain a database of the user's identifications and passwords for various networks within the work environment. These passwords may be accessible by the user in the work-centric configuration, but locked out during other configurations of the computing device. Similarly, the computing device may provide the user with a favorites list of work-related web pages and documents for ease in access during this configuration. Generally, any configurable aspect of a computing device may be configured in response to the docking station location received by the docking station.

An extension of the security measures applied in operation 510 is illustrated in operations 512-516. Similar to FIG. 4, the computing device may determine the identification of a network connected to the docking station. In this example, the network is most likely a work-related network. Thus, the network will most likely be recognized by the computing device as a secure network. Thus, in operation 512, the computing device may be further configured to allow access to the network with relatively low security protection to the computing device. Related user identifications and passwords may also be provided to the user of the computing device to help the user navigate through the work-related network.

In contrast, the same computing device may be docked in a computer docking station at the user's home, in which the computing device may operate under a home configuration that provides different functionality to the user when the device is docked at work. For example, the display settings, such as background and theme of the computing device may be altered in response to the home setting. In addition, the work-related software applications may be removed from the user's desktop and/or rendered inactive while other more home-centric applications are activated, such as on-line music management applications or gaming applications. Several personal user profiles may also be loaded, such as a preferred private email provider and a list of personal favorite websites of the users. In general, the aspects of the computing device may be altered in response to the user docking the computing device in a docking station at the user's home that are geared towards the user's private computing needs.

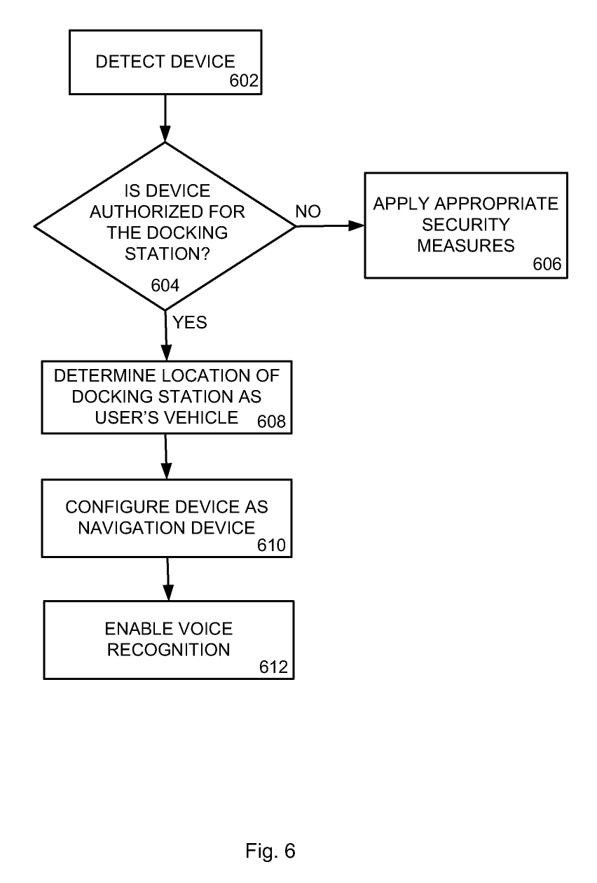

In another example, the computing device may be docked in a docking station located in the user's car. FIG. 6 is a flow chart of docking station altering the functionality of a computing device into a navigation-related computing device based on the location of the docking station in a user's vehicle.

Similar to the above examples, the docking station may first detect the device in operation 602 and determine the computing device is authorized to access the station in operation 604. Several security measures may be activated if the device is not authorized in operation 606. Otherwise, the location of the docking station as being in the user's car is determined in operation 608.

Once the vehicle location is determined, several software applications may be started in response. For example, the computing device may automatically be converted into a navigation device, including GPS functionality with maps and directions. In addition, the computing device may disable the inputs to the computing device and convert into a voice-command only mode so that the user can control the device without removing his hands from the wheel of the vehicle, as shown in operation 612. Other software applications may also be loaded, such as a digital music player or cell phone capabilities of the computing device that the user may use while driving.

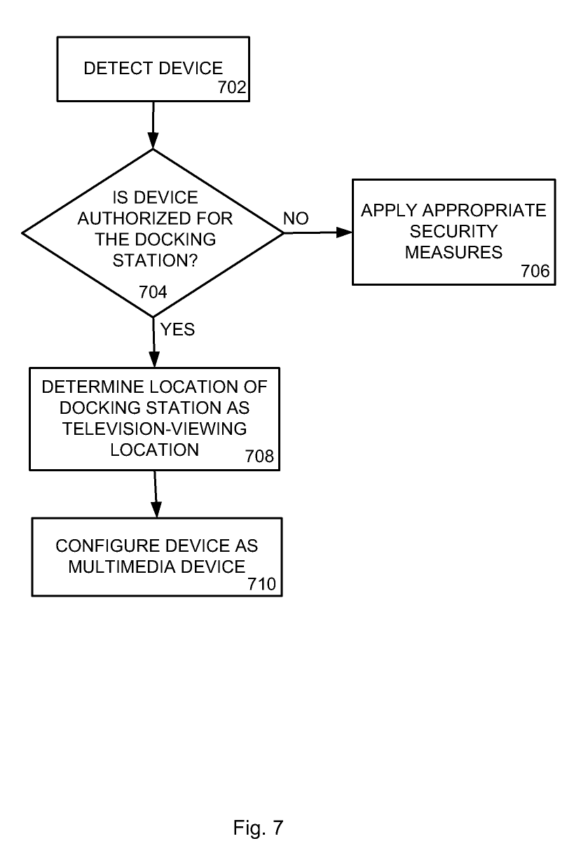

FIG. 7 is a flow chart of docking station altering the functionality of a computing device into a television-related computing device based on the location of the docking station in a television viewing location. Similarly to FIGS. 4-6, the computing device is detected by the television-viewing docking station in operation 702 and a determination is made as to whether the device is authorized to access the docking station in operation 704. If it is determined that the computing device is not authorized, the docking station may lock the device or otherwise prevent the device from accessing the network in operation 706. In operation 708, the docking station identifies its location as being located in a user's living room or other viewing location.

Once the television-viewing location is determined, the computing device may automatically be converted into a television viewing system by activating one or more software programs and hardware devices in operation 710. For example, drivers for a television display, sound-systems and other peripheral devices related to television viewing may be activated. In addition, several on-line television websites may be accessed by the computing device to retrieve content for viewing by the user. Multimedia content that may be stored on the computing device may also be accessed and presented to the user or provided on the desktop of the computing device. Generally, any configurable aspect of a computing device that provides a television-viewing experience to a user may be configured in response to the docking station location being a television-viewing location.

Several security measures may also be employed in the television-centric configuration. For example, the computing device may lock one or more inputs to the device to prevent interruption of the multimedia program being viewed. Further, the computing device may require a password to access the device to prevent someone other than the user from accessing the device while it is docked in the docking station. Such security measures may be configured in any number of ways by the computing device.

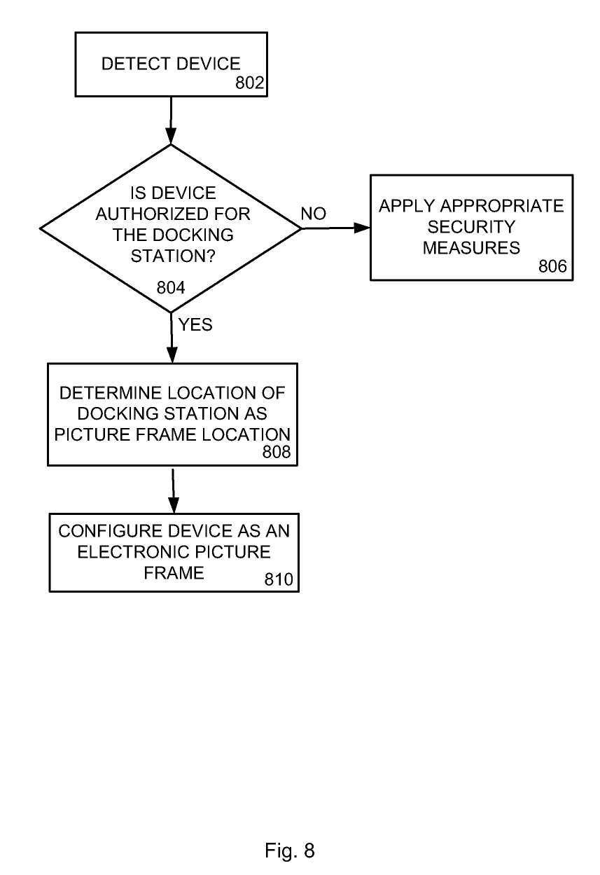

FIG. 8 is a flow chart of docking station altering the functionality of a computing device into an electronic picture frame based on the location of the docking station in a picture-viewing location. Beginning in operation 802, the computing device is detected by the electronic picture frame docking station and a determination is made as to whether the device is authorized to access the docking station in operation 804. If it is determined that the computing device is not authorized, the docking station may lock the device or otherwise prevent the device from accessing the docking station in operation 806. In operation 808, the docking station identifies its location as being located in a picture-viewing location.

Once the picture-viewing location is determined, the computing device may automatically be converted into an electronic picture frame by accessing one or more photo catalogs and periodically displaying the photos on the display screen of the computing device, similar to an electronic picture frame. Further, the types of photos selected may be based on information provided to the computing device. For example, a date and time may be passed to the computing device by the docking station. In response, the computing device may select or be directed to select a particular set of photos that corresponds to the date and time. Generally, any information may be used by the computing device to customize the number and types of photos displayed when the computing device accesses an electronic photo docking station.

In addition, the computing device may employ one or more power saving routines if a particular configuration does not require high-volume processing, such as an electronic picture frame configuration. In this configuration, the'computing device may run slower to reduce the amount of power used by the device. Other routines may also be employed, such as reducing the amount of storage space utilized by the device and locking out the rest of the hard drive for other storage and uses. When the device is coupled to a different docking station at a separate location, then these routines may be removed such that the computing device may operate at full capacity, depending on the docking station location.

In a similar manner as described above, the computing device may be configured to provide any functionality supported by the device in response to the location of the docking station. For example, the computer could be configured as a desktop computer, handheld computing device, personal digital assistant, mobile telephone, music or audio player (such as an MP3 player), health or medical device, auto/vehicle-mounted device, gaming console, display device, wireless internet access device, backup storage device and so on. Further, each selected configuration may have a particular set of hardware components and software programs that support the underlying functionality of the device that are initialized and/or loaded in response to the setting of the configuration of the computing device. Generally, the computing device may provide any functionality that is supported by the device.

FIG. 9 is a block diagram illustrating an example of a computer system device 900 which may be used in implementing embodiments of the present invention. In general, the computing device and docking station may include any of the described components. In addition, the computing device and docking station may omit some of the described components. The computer system (system) includes one or more processors 902-906. Processors 902-906 may include one or more internal levels of cache (not shown) and a bus controller or bus interface unit to direct interaction with the processor bus 912. Processor bus 912, also known as the host bus or the front side bus, may be used to couple the processors 902-906 with the system interface 914. System interface 914 may be connected to the processor bus 912 to interface other components of the system 900 with the processor bus 912. For example, system interface 914 may include a memory controller 918 for interfacing a main memory 916 with the processor bus 912. The main memory 916 typically includes one or more memory cards and a control circuit (not shown). System interface 914 may also include an input/output (I/O) interface 920 to interface one or more I/O bridges or I/O devices with the processor bus 912. One or more I/O controllers and/or I/O devices may be connected with the I/O bus 926, such as I/O controller 928 and I/O device 930, as illustrated.

I/O device 930 may also include an input device (not shown), such as an alphanumeric input device, including alphanumeric and other keys for communicating information and/or command selections to the processors 902-906. Another type of user input device includes cursor control, such as a mouse, a trackball, or cursor direction keys for communicating direction information and command selections to the processors 902-906 and for controlling cursor movement on the display device.

System 900 may include a dynamic storage device, referred to as main memory 916, or a random access memory (RAM) or other devices coupled to the processor bus 912 for storing information and instructions to be executed by the processors 902-906. Main memory 916 also may be used for storing temporary variables or other intermediate information during execution of instructions by the processors 902-906. System 900 may include a read only memory (ROM) and/or other static storage device coupled to the processor bus 912 for storing static information and instructions for the processors 902-906. The system set forth in FIG. 9 is but one possible example of a computer system that may employ or be configured in accordance with aspects of the present disclosure.

According to one embodiment, the above techniques may be performed by computer system 900 in response to processor 904 executing one or more sequences of one or more instructions contained in main memory 916. These instructions may be read into main memory 916 from another machine-readable medium, such as a storage device. Execution of the sequences of instructions contained in main memory 916 may cause processors 902-906 to perform the process steps described herein. In alternative embodiments, circuitry may be used in place of or in combination with the software instructions. Thus, embodiments of the present disclosure may include both hardware and software components.

A machine readable medium includes any mechanism for storing information in a form (e.g., software, processing application) readable by a machine (e.g., a computer). Such media may take the form of, but is not limited to, non-volatile media and volatile media. Non-volatile media includes optical or magnetic disks. Volatile media includes dynamic memory, such as main memory 916. Common forms of machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions.

It should be noted that the flowcharts of FIGS. 4-7 are illustrative only. Alternative embodiments of the present invention may add operations, omit operations, or change the order of operations without affecting the spirit and scope of the present invention.

The foregoing merely illustrates certain principles and embodiments of the invention. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the invention and are thus within the spirit and scope of the present invention. From the above description and drawings, it will be understood by those of ordinary skill in the art that the particular embodiments shown and described are for purposes of illustrations only and are not intended to limit the scope of the present invention. References to details of particular embodiments are not intended to limit the scope of the invention.

1. A method for configuring a computing device comprising:
receiving a location indicator of a docking station coupled to a computing device;
selecting a system configuration of the computing device based on the location indicator, the system configuration utilizing one or more hardware and software components of the computing device to provide a functionality of the computing device; and
altering the functionality of the computing device based on the determined system configuration.

2. The method of claim 1 further comprising:
altering one or more security settings of the computing device based on the determined system configuration.

3. The method of claim 1 further comprising:
altering one or more display settings of the computing device based on the determined system configuration.

4. The method of claim 2 further comprising:
detecting a network coupled to the docking station;
obtaining a network security level; and
further altering the security settings of the computing device in response to the security level of the network.

5. The method of claim 1 further comprising:
locking the computing device if the computing device is not recognized by the docking station.

6. The method of claim 1 further comprising:
providing the location indicator to the docking station when the docking station is in a configuration mode, the location indicator indicating the location of the docking station.

7. The method of claim 1 further comprising:
obtaining the location indicator from a network coupled to the docking station.

8. The method of claim 1 wherein the computing device couples to the docking station wirelessly.

9. The method of claim 1 wherein the selecting operation comprises:
comparing the location indicator to a list of docket station locations, the list including corresponding system configurations for each of the listed docket station locations.

10. The method of claim 1 wherein the altering operation comprises:
initializing one or more software applications that correspond to the selected system configuration.

11. The method of claim 2 wherein the altering one or more security settings operation comprises:
loading one or more user identifications and passwords corresponding to the selected system configuration.

12. A docking station for a computing device comprising:
a processor;
a machine-readable medium configured to maintain a location indicator that indicates a location of the docking station; and
an interface configured to couple to a computing device to provide the location indicator to the computing device such that the computing device alters the functionality of the computing device in response to the location indicator.

13. The docking station of claim 12 further comprising:
a network connection, wherein one or more security settings of the computing device are altered in response to the security level of the network.

14. The docking station of claim 12 wherein the processor receives the location indicator from the computing device when the computing device docks with the docking station and stores the location indicator in the machine-readable medium.

15. The docking station of claim 13 wherein the processor receives the location indicator from the network and stores the location indicator in the machine-readable medium.

16. The docking station of claim 12 wherein the processor is configured to perform the operations of:
selecting a system configuration of the computing device based on the location indicator; and
transmitting the system configuration to the computing device to alter the functionality of the computing device in response to the location indicator.

17. A system for configuring the functionality of a computing device based on a location comprising:
a computing device; and
a docking station configured to communicate with the computing device such that a functionality of the computing device is selected based on a location indicator provided by the docking station to the computing device.

18. The system of claim 17 further comprising:
a network coupled to the docking station and wherein the computing device alters one or more security settings in response to the security level of the network.

19. The system of claim 17 wherein the functionality of the computing device is a computer.

20. The system of claim 17 wherein the functionality of the computing device is a navigational electronic device.

21. The system of claim 17 wherein the functionality of the computing device is an electronic picture frame device.

22. The system of claim 17 wherein the functionality of the computing device is a mobile phone.

23. The system of claim 17 wherein the functionality of the computing device is a television viewing device.

24. The system of claim 17 wherein the functionality of the computing device is a gaming console device.

25. The system of claim 17 wherein the functionality of the computing device is a display device.

26. The system of claim 17 wherein the functionality of the computing device is a wireless internet access device.

27. The system of claim 17 wherein the functionality of the computing device is a backup storage device.
